(19) United States
(12) Patent Application Publication
(10) Pub. No.: US 2026/0228042 A1
(43) Pub. Date: Aug. 6, 2026

(54) APPARATUS AND METHOD FOR SCHEDULING MULTIPLE INSPECTION PROCESSES

(71) Applicant: SAMSUNG ELECTRONICS CO., LTD., Suwon-si (KR)

(72) Inventors: Hoyong SON, Suwon-si (KR); Hyunjun PARK, Suwon-si (KR)

(73) Assignee: SAMSUNG ELECTRONICS CO., LTD., Suwon-si (KR)

(21) Appl. No.: 19/635,407

(22) Filed: Mar. 31, 2026

Related U.S. Application Data
(63) Continuation of application No. PCT/KR2024/018238, filed on Nov. 19, 2024.

(30) Foreign Application Priority Data
Nov. 30, 2023 (KR) 10-2023-0171451

(51) Int. Cl. G06F 9/48

(52) U.S. Cl. CPC G06F 9/4881

(57) ABSTRACT

An electronic device identifies scheduling information associated with multiple inspection processes, and executes the multiple inspection processes on the basis of the scheduling information, wherein execution time periods of the multiple inspection processes, which are indicated by the scheduling information, overlap or do not overlap each other. The scheduling information is determined on the basis of inspection data associated with previous execution results of the multiple inspection processes; and the inspection data includes at least one of a failure rate corresponding to the multiple inspection processes, respectively, a required time corresponding to the multiple inspection processes, respectively, and data associated with a point in time when inspection can be started after booting corresponding to the multiple inspection processes, respectively, the failure rate and required time being based on that the time periods in which the multiple inspection processes have been executed overlap.

### CROSS-REFERENCE TO RELATED APPLICATIONS

This application is a continuation application, under 35 U.S.C. § 111(a), of an International Application No. PCT/KR2024/018238, filed on Nov. 19, 2024, which is based on and claims priority to Korean patent application number 10-2023-0171451, filed on Nov. 30, 2023, the disclosures of which is incorporated by reference herein in its entirety.

### TECHNICAL FIELD

The disclosure relates to an apparatus and a method for scheduling a plurality of inspection processes associated with a hardware component of an electronic device.

### BACKGROUND ART

An electronic device (e.g., a display device such as a TV, a smart monitor, or a digital signage) may be produced as a finished product assembled with various hardware (HW) components and sold to a customer. An HW component may be defective during a production process and/or an assembly process, and may be deteriorated or damaged based on a usage time or a usage pattern of the customer. In case that a problem occurs in the electronic device due to an abnormality in the HW component, a service network or a service application provided by a manufacturer may be used for problem resolution.

As one example of the service application, a self-diagnosis solution may be used. The self-diagnosis solution may be installed on the electronic device and executed by a user. The self-diagnosis solution may be used to autonomously inspect a state of the electronic device without connection of an external device, or to identify whether the electronic device has a problem or whether a repair is needed.

### DISCLOSURE

### Technical Problem

A service application such as the self-diagnosis solution may simultaneously perform a plurality of inspection processes in order to quickly complete the plurality of inspection processes. However, in case that the plurality of inspection processes are simultaneously performed, a problem due to a resource conflict may occur. For example, the resource conflict may occur in case that the plurality of inspection processes simultaneously performed are associated with an identical HW component. In case that the resource conflict occurs, at least one of the plurality of inspection processes that has failed to preempt the HW component may fail.

In order to prevent the problem of the resource conflict, a method may be used in which the user checks the HW component associated with each inspection process and then manually adjusts an execution order of the inspection process associated with the resource conflict. The resource conflict may occur differently for each product model of the electronic device. Accordingly, even for the electronic device of an identical type, the user may have an inconvenience of having to manually adjust the execution order for each product model.

The plurality of inspection processes may be automatically performed without intervention of the user. In this case, in case that at least one of the plurality of inspection processes simultaneously performed fails, the failed inspection process may be individually retried. For example, the failed inspection process may be retried until it succeeds. However, since the inspection process associated with a genuinely defective HW component may not succeed regardless of repeated retries, a problem of unnecessarily increasing an execution time due to the repeated retries may occur.

### Technical Solution

An embodiment of the disclosure may provide an apparatus and a method for scheduling a plurality of inspection processes.

An embodiment of the disclosure may provide an apparatus and a method for scheduling a plurality of inspection processes associated with a hardware component of an electronic device.

An embodiment of the disclosure may provide an apparatus and a method for scheduling a plurality of inspection processes based on inspection data including previous execution results of the plurality of inspection processes.

An embodiment of the disclosure may provide an apparatus and a method for scheduling a plurality of inspection processes such that execution time periods of the plurality of inspection processes overlap or do not overlap, considering at least one of a failure rate or a required time in case that the plurality of inspection processes identified based on the inspection data are simultaneously performed, or data associated with an available inspection start time after booting of each inspection process.

A device according to an embodiment of the disclosure may include: an electronic device comprising memory to store at least one program; and at least one processor electrically connectable to the memory and executing at least one instruction of the at least one program stored in the memory. The at least one processor is configured to: identify scheduling information associated with a plurality of inspection processes, and perform the plurality of inspection processes based on the scheduling information; execution time periods of the plurality of inspection processes indicated by the scheduling information overlap or do not overlap. The scheduling information is determined based on inspection data associated with previous execution results of the plurality of inspection processes; and the inspection data may include: at least one of a failure rate corresponding to the plurality of inspection processes, respectively, based on execution time periods of the plurality of inspection processes overlapping, a required time corresponding to the plurality of inspection processes, respectively, based on the execution time periods of the plurality of inspection processes overlapping, or data associated with an available inspection start time after booting corresponding to the plurality of inspection processes, respectively.

According to an embodiment, the scheduling information is adjusted based on the inspection data subsequent to post-execution of the plurality of inspection processes.

According to an embodiment, the electronic device may further comprise a transceiver performing communication with a server; and the at least one processor may control the transceiver to transmit an inspection list associated with the plurality of inspection processes to the server, and to receive the scheduling information from the server based on transmitted the inspection list.

According to an embodiment, the electronic device may further comprise a transceiver performing communication with a server; and the at least one processor may control the transceiver to transmit an inspection list associated with the plurality of inspection processes to the server, and to receive the inspection data from the server based on transmitted the inspection list, perform scheduling for the plurality of inspection processes based on the received inspection data, and identify the scheduling information including a result of the scheduling.

According to an embodiment, the at least one processor may collect inspection data associated with previous execution results of the plurality of inspection processes, perform scheduling for the plurality of inspection processes based on the collected inspection data, and identify the scheduling information including a result of the scheduling.

According to an embodiment, the scheduling information may include information indicating an execution order corresponding to the plurality of inspection processes; an execution order of at least one first inspection process among the plurality of inspection processes may be determined to be different from an execution order of at least one second inspection process among the plurality of inspection processes, based on a condition associated with the inspection data; and the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

According to an embodiment, the execution order of the at least one first inspection process may be an order before execution of the at least one second inspection process starts, or an order after execution of the at least one second inspection process ends.

According to an embodiment, the plurality of inspection processes may be associated with a plurality of hardware components included in the electronic device.

Another device according to an embodiment of the disclosure may include: a server comprising memory storing at least one program; and at least one processor electrically connected to the memory and executing at least one instruction of the program stored in the memory; the at least one processor is configured to: identify inspection data associated with previous execution results of a plurality of inspection processes, and perform scheduling based on the identified inspection data such that the plurality of inspection processes are performed in time periods that overlap or do not overlap; and the inspection data may include at least one of a failure rate corresponding to the plurality of inspection processes, respectively, based on execution time periods of the plurality of inspection processes overlapping, a required time corresponding to the plurality of inspection processes, respectively, based on the execution time periods of the plurality of inspection processes overlapping, or data associated with an available inspection start time after booting corresponding to the plurality of inspection processes, respectively.

According to an embodiment, the server may further comprise a transceiver performing communication with an electronic device, and the at least one processor may control the transceiver to receive an inspection list associated with the plurality of inspection processes from the electronic device, and to transmit scheduling information including a result of the scheduling to the electronic device in response to having received the inspection list.

According to an embodiment, the at least one processor may generate scheduling information including information indicating an execution order of each of the plurality of inspection processes, based on a result of the scheduling; an execution order of at least one first inspection process among the plurality of inspection processes may be set to be different from an execution order of at least one second inspection process among the plurality of inspection processes, based on a condition associated with the inspection data; and the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

A method according to an embodiment of the disclosure may include: a method of performing a plurality of inspection processes by an electronic device, the method comprising identifying scheduling information associated with the plurality of inspection processes; and performing the plurality of inspection processes based on the scheduling information; execution time periods of the plurality of inspection processes indicated by the scheduling information overlap or do not overlap; the scheduling information is determined based on inspection data associated with previous execution results of the plurality of inspection processes; and the inspection data may include: at least one of a failure rate corresponding to the plurality of inspection processes, respectively, based on execution time periods of the plurality of inspection processes overlapping, a required time corresponding to the plurality of inspection processes, respectively, based on the execution time periods of the plurality of inspection processes overlapping, or data associated with an available inspection start time after booting corresponding to the plurality of inspection processes, respectively.

According to an embodiment, the identifying of the scheduling information may comprise transmitting an inspection list associated with the plurality of inspection processes to a server; in response to having transmitted the inspection list, receiving the scheduling information from the server; and identifying the received scheduling information.

According to an embodiment, the identifying of the scheduling information may comprise transmitting an inspection list associated with the plurality of inspection processes to a server; in response to having transmitted the inspection list, receiving the inspection data from the server; performing scheduling for the plurality of inspection processes based on the received inspection data; and identifying the scheduling information including a result of the scheduling.

According to an embodiment, the identifying of the scheduling information may comprise collecting inspection data associated with previous execution results of the plurality of inspection processes; performing scheduling for the plurality of inspection processes based on the collected inspection data; and identifying the scheduling information including a result of the scheduling.

According to an embodiment, the scheduling information may include information indicating an execution order corresponding to the plurality of inspection processes; an execution order of at least one first inspection process among the plurality of inspection processes may be determined to be different from an execution order of at least one second inspection process among the plurality of inspection processes, based on a condition associated with the inspection data; and the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

According to an embodiment, the execution order of the at least one first inspection process may be an order before execution of the at least one second inspection process starts, or an order after execution of the at least one second inspection process ends.

According to an embodiment, the plurality of inspection processes may be associated with a plurality of hardware components included in the electronic device.

Another method according to an embodiment of the disclosure includes: a method of scheduling a plurality of inspection processes by a server, the method comprising identifying inspection data associated with previous execution results of the plurality of inspection processes; and performing scheduling based on the identified inspection data such that the plurality of inspection processes are performed in time periods that overlap or do not overlap, and the inspection data may include: at least one of a failure rate corresponding to the plurality of inspection processes, respectively, based on execution time periods of the plurality of inspection processes overlapping, a required time corresponding to the plurality of inspection processes, respectively, based on the execution time periods of the plurality of inspection processes overlapping, or data associated with an available inspection start time after booting corresponding to the plurality of inspection processes, respectively.

According to an embodiment, the method may further comprise receiving an inspection list associated with the plurality of inspection processes from the electronic device; and in response to having received the inspection list, transmitting scheduling information including a result of the scheduling to the electronic device.

According to an embodiment, the method may further comprise generating scheduling information including information indicating an execution order corresponding to the plurality of inspection processes, based on a result of the scheduling; an execution order of at least one first inspection process among the plurality of inspection processes may be set to be different from an execution order of at least one second inspection process among the plurality of inspection processes, based on a condition associated with the inspection data; and the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

### DESCRIPTION OF DRAWINGS

FIG. 1 is a view illustrating a system for scheduling a plurality of inspection processes according to an embodiment.

FIG. 2 is a signal flow diagram between an electronic device and a server for performing a plurality of inspection processes according to an embodiment.

FIG. 3 is another signal flow diagram between an electronic device and a server for performing a plurality of inspection processes according to an embodiment.

FIG. 4A is a view illustrating data associated with a failure rate of each of simultaneously performed inspection processes according to an embodiment.

FIG. 4B is a view illustrating data associated with a required time of each of simultaneously performed inspection processes according to an embodiment.

FIG. 4C is a view illustrating data associated with an available inspection start time after booting of each of simultaneously performed inspection processes according to an embodiment.

FIG. 5 is a flowchart illustrating an operation of an electronic device according to an embodiment.

FIG. 6 is a flowchart illustrating an operation in which an electronic device identifies scheduling information according to an embodiment.

FIG. 7 is a flowchart illustrating another operation in which an electronic device identifies scheduling information according to an embodiment.

FIG. 8 is a flowchart illustrating yet another operation in which an electronic device identifies scheduling information according to an embodiment.

FIG. 9 is a flowchart illustrating an operation in which an electronic device or a server sets an execution order of an inspection process according to an embodiment.

FIG. 10 is a flowchart illustrating operations of a server according to an embodiment;

FIG. 11 is a flowchart illustrating an operation in which a server provides scheduling information to an electronic device according to an embodiment.

FIG. 12 is a block diagram illustrating a configuration of an electronic device according to an embodiment.

FIG. 13 is a block diagram illustrating a configuration of a server according to an embodiment.

In the following description, referring to the accompanying drawings, certain examples for implementing the disclosed invention are illustrated as examples in the drawings. Further, other examples may be used and structural changes or modification may be made without departing from the scope of various examples.

### MODE FOR INVENTION

Hereinafter, various embodiments of the disclosure will be described in detail with reference to the accompanying drawings so that those having ordinary knowledge in the technical field to which the disclosure pertains may easily practice the disclosed invention with ease. However, the disclosure may be implemented in various different forms and is not limited to the embodiments described herein. With regard to description of drawings, the same or like components may be indicated by the same or like reference numerals. Further, in the drawings and their related descriptions, descriptions of well-known functions and configurations may be omitted for clarity and brevity.

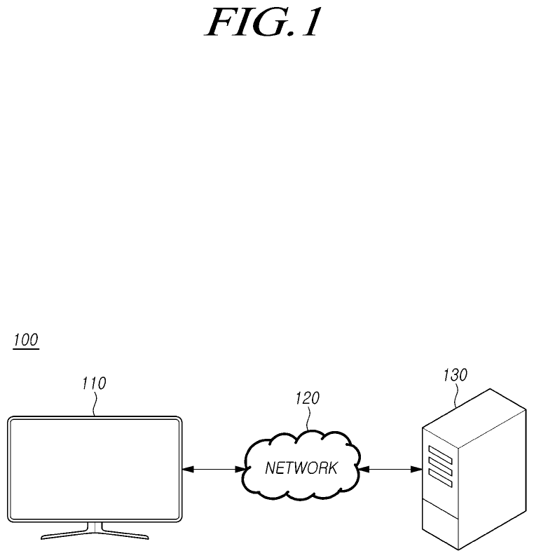

FIG. 1 is a view illustrating a system for scheduling a plurality of inspection processes according to an embodiment.

Referring to FIG. 1, a system 100 for scheduling a plurality of inspection processes may include an electronic device 110 and a server 130.

According to an example, the electronic device 110 may be a display device such as a TV, a smart monitor, or a digital signage, a home appliance such as a refrigerator, a washer, a dryer, or an air conditioner, or a mobile terminal such as a tablet or a mobile phone. In FIG. 1, as one example, a case in which the electronic device 110 is a TV is illustrated.

According to an example, the server 130 may be a server capable of performing various processing such as various data collection, storage, and processing. The server 130 may be referred to by various terms different from a server, e.g., a term such as a data server, a network server, a database, a database server, an inspection server, or an inspection data server.

According to an example, the electronic device 110 and the server 130 may be connected through a network 120 and may communicate based on various wired and wireless communication technologies. For example, the wireless communication technology may include at least one of wireless fidelity (Wi-Fi), Bluetooth, long term evolution (LTE), LTE advance (LTE-A), or new radio (NR) communication technology.

According to an example, the electronic device 110 or the server 130 may collect and store various data (e.g., scheduling information and/or inspection data) associated with a plurality of inspection processes. For example, the electronic device 110 may perform a plurality of inspection processes and store inspection data associated with an execution result of the plurality of inspection processes. For example, the server 130 may receive and store inspection data associated with an execution result of a plurality of inspection processes from one or more electronic devices. The one or more electronic devices may include the electronic device 110 and/or at least one other electronic device different from the electronic device 110.

According to an example, the electronic device 110 or the server 130 may perform scheduling for the plurality of inspection processes based on collected inspection data. The electronic device 110 may perform the plurality of inspection processes based on a scheduling result performed by the electronic device 110 or the server 130.

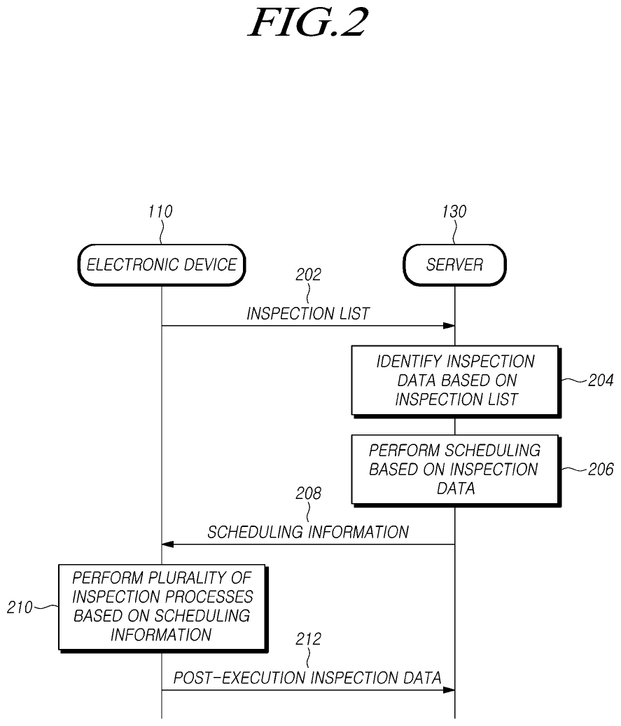

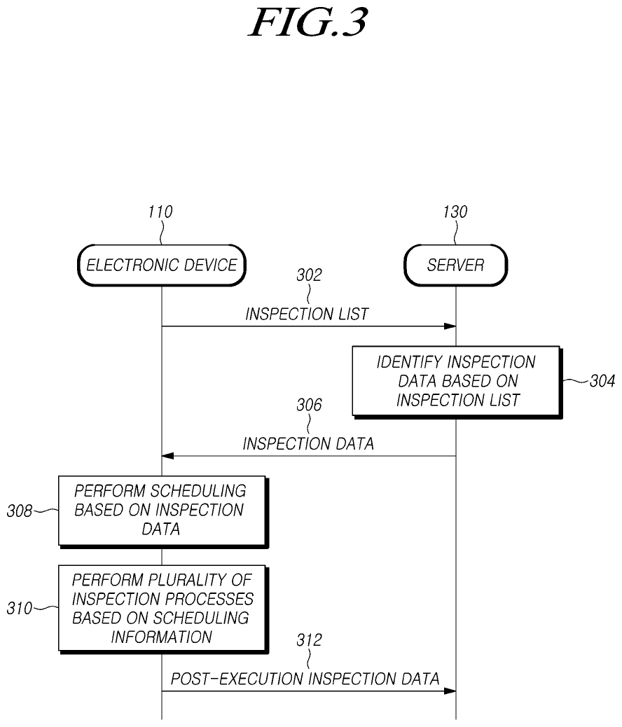

Hereinafter, an operation in which the electronic device 110 performs a plurality of inspection processes based on communication with the server 130 is described with reference to FIGS. 2 and 3.

FIG. 2 is a signal flow diagram between an electronic device and a server for performing a plurality of inspection processes according to an embodiment.

Referring to FIG. 2, in operation 202, the electronic device 110 may transmit an inspection list, and the server 130 may receive the inspection list transmitted by the electronic device 110. According to an example, the inspection list may include identification information or model information (e.g., a product model name, a model code, or model number information) of the electronic device 110, and/or information on each of hardware (HW) components included in or connected to the electronic device 110 (e.g., at least one of identification information or model information of each of the HW components, normal operation status information of each of the HW components, after service (AS) information of each of the HW components (e.g., AS status information or AS history information), or inspection method or inspection type information of each of the HW components). According to an example, in case that the electronic device 110 is a TV, the HW components may include at least some of a speaker, a sensor (e.g., a gyro sensor), a camera, an antenna, a tuner, a communication module (e.g., a Wi-Fi or Bluetooth module), a high-definition multimedia interface (HDMI) or universal serial bus (USB) port, a codec chip, an input/output unit, and a security block.

In operation 204, the server 130 may identify inspection data based on the received inspection list. For example, the server 130 may identify inspection data corresponding to information included in the inspection list (e.g., the identification information or model information of the electronic device 110, and/or the identification information or model information of each HW component) from pre-stored inspection data. The identified inspection data may include data associated with previous execution results of a plurality of inspection processes.

According to an example, the data associated with the previous execution results of the plurality of inspection processes may include data collected by the server 130. For example, the data collected by the server 130 may include at least one of a start time and an end time of each inspection process, data associated with success or failure of each inspection process, or a failure rate of each of simultaneously performed inspection processes, a required time of each of the simultaneously performed inspection processes, or data associated with an available inspection start time after booting of each inspection process.

According to an example, the inspection processes being simultaneously performed may mean that execution time periods of the inspection processes overlap, or that the inspection processes are performed together at a specific time or time period. According to an example, the execution time periods of the inspection processes may entirely or partially overlap. For example, in case that a first inspection process is performed for 1 to 10 seconds after booting, a second inspection process is performed for 5 to 10 seconds after booting, and a third process is performed for 5 to 10 seconds after booting, the execution time periods of the first inspection process and the second inspection process or the third process may partially overlap, and the execution time periods of the second inspection process and the third process may entirely overlap.

In operation 206, the server 130 may perform scheduling for the plurality of inspection processes based on the identified inspection data.

In operation 208, the server 130 may transmit scheduling information including a scheduling execution result, and the electronic device 110 may receive the scheduling information transmitted from the server 130.

In operation 210, the electronic device 110 may perform the plurality of inspection processes based on the scheduling information received from the server 130.

In operation 212, the electronic device 110 may perform the plurality of inspection processes and transmit post-execution inspection data to the server 130.

According to an example, the post-execution inspection data may include at least one of a start time and an end time of each inspection process, data associated with success or failure of each inspection process, or a failure rate of each of simultaneously performed inspection processes, a required time of each of the simultaneously performed inspection processes, or data associated with an available inspection start time after booting of each inspection process.

According to an example, the post-execution inspection data may be transmitted for an inspection data collection operation of the server 130. The post-execution inspection data may be stored in the server 130 and used for scheduling a plurality of inspection processes thereafter.

FIG. 3 is another signal flow diagram between an electronic device and a server for performing a plurality of inspection processes according to an embodiment.

Referring to FIG. 3, in operation 302, the electronic device 110 may transmit an inspection list, and the server 130 may receive the inspection list transmitted by the electronic device 110.

In operation 304, the server 130 may identify inspection data based on the received inspection list. According to an example, operations 302 and 304 may correspond to operations 202 and 204 of FIG. 2.

In operation 306, the server 130 may transmit the identified inspection data to the electronic device 110, and the electronic device 110 may receive the inspection data transmitted from the server 130. According to an example, the server 130 may perform an operation of collecting inspection data and providing the inspection data to the electronic device 110.

In operation 308, the electronic device 110 may perform scheduling based on the inspection data received from the server 130.

In operation 310, the electronic device 110 may perform the plurality of inspection processes based on scheduling information including a scheduling result.

In operation 312, the electronic device 110 may perform the plurality of inspection processes and transmit post-execution inspection data to the server 130. According to an example, the post-execution inspection data may be transmitted for a collection operation of the server 130.

According to an example, unlike FIGS. 2 and 3, the electronic device 110 may autonomously perform the plurality of inspection processes without communication with the server 130. For example, the electronic device 110 may generate an inspection list upon detecting an abnormality in an operation of the electronic device 110 or detecting a problem occurring in the HW components. The generated inspection list may include information associated with the HW components to be inspected. The electronic device 110 may identify inspection data corresponding to the inspection list from pre-stored (or previously collected) inspection data. The electronic device 110 may perform scheduling for the plurality of inspection processes based on the identified inspection data and perform the plurality of inspection processes based on a scheduling result. The electronic device 110 may store post-execution inspection data and use the post-execution inspection data for scheduling a plurality of inspection processes thereafter.

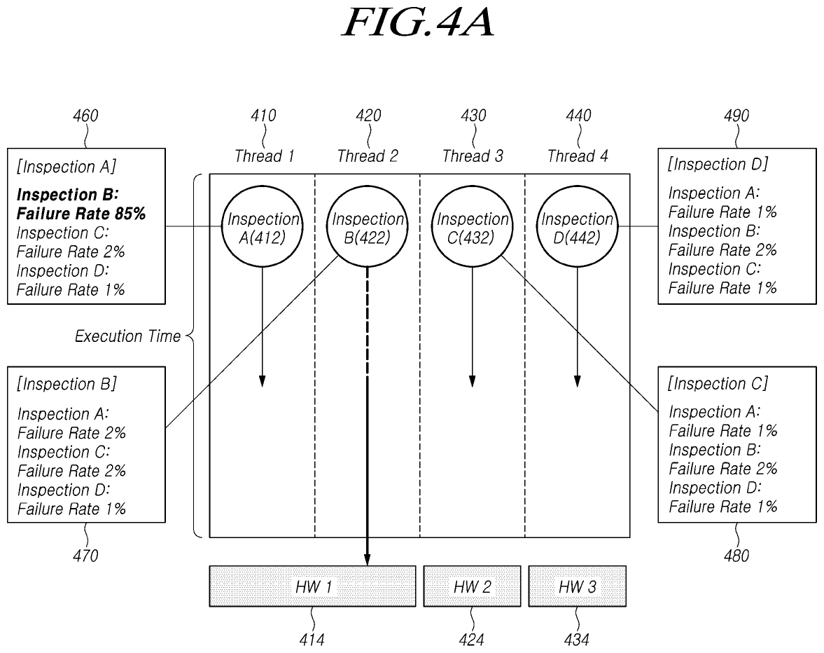

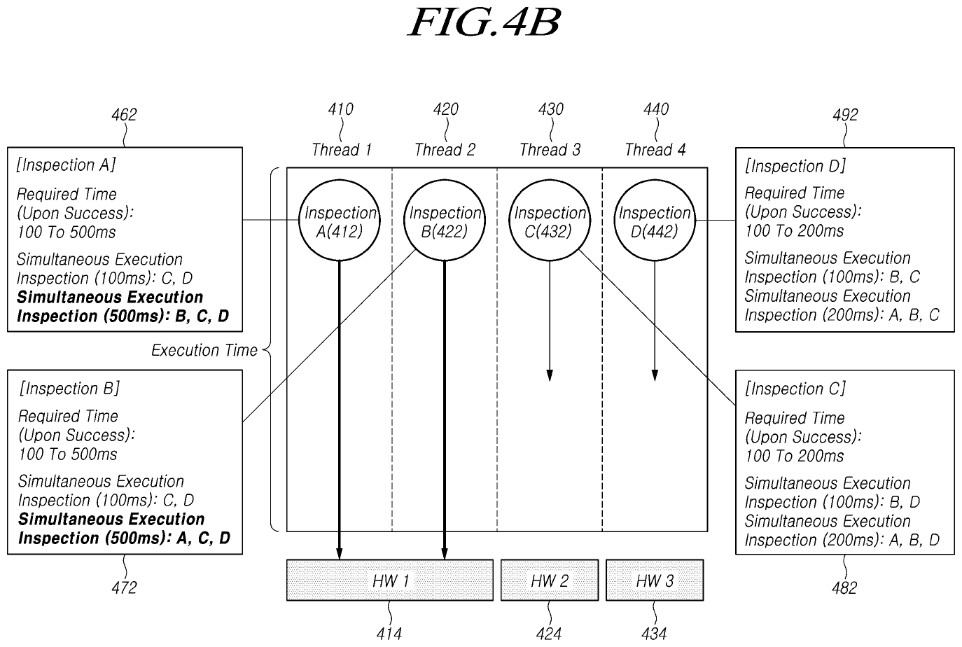

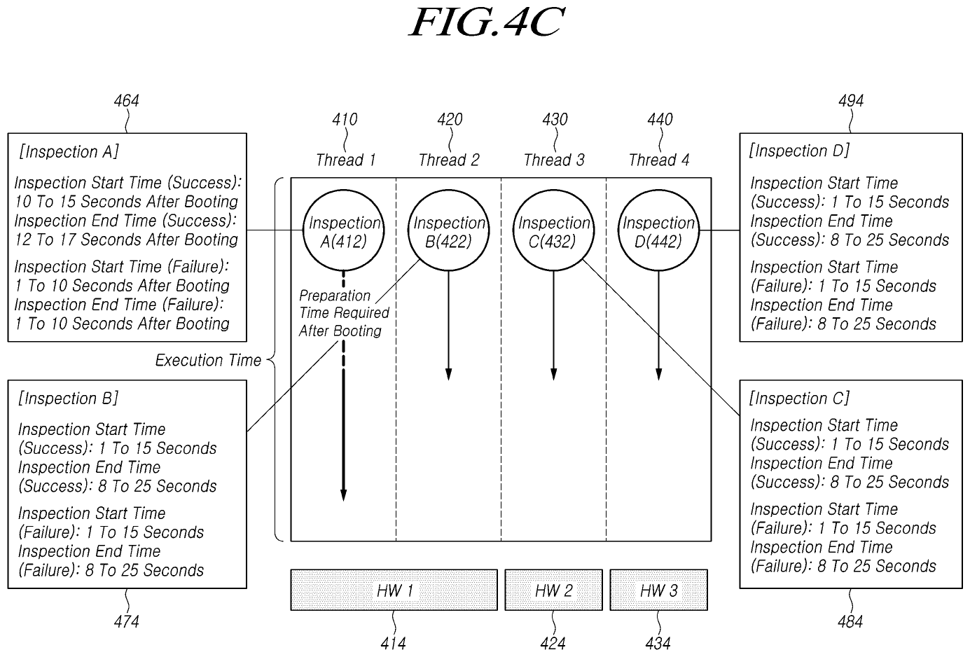

Inspection data according to an embodiment may include at least one of a failure rate of each of simultaneously performed inspection processes, a required time of each of the simultaneously performed inspection processes, or data associated with an available inspection start time after booting of each inspection process. Data related thereto is described in detail with reference to FIGS. 4A to 4C.

FIG. 4A is a view illustrating data associated with a failure rate of each of simultaneously performed inspection processes according to an embodiment.

Referring to FIG. 4A, the plurality of inspection processes may include inspection A 412, inspection B 422, inspection C 432, and inspection D 442. Inspection A 412, inspection B 422, inspection C 432, and inspection D 442 are each an inspection process and may include an inspection procedure, an inspection course, or an inspection operation associated with a specific HW.

At least two of the plurality of inspection processes may be simultaneously performed. For example, execution time periods of the at least two inspection processes may entirely or partially overlap. According to an example, inspection A 412, inspection B 422, inspection C 432, and inspection D 442 may be simultaneously performed. For example, execution time periods of inspection A 412, inspection B 422, inspection C 432, and inspection D 442 may at least partially overlap. For convenience of description, hereinafter, it is assumed that start times of inspection A 412, inspection B 422, inspection C 432, and inspection D 442 are identical, and simultaneous execution is described as inspection A 412, inspection B 422, inspection C 432, and inspection D 442 being performed during a specific time period from the start time.

Inspection A 412, inspection B 422, inspection C 432, and inspection D 442 may be classified and performed in a designated work unit (e.g., a thread (hereinafter referred to as ‘Thread’)), and each may be referred to as a unit inspection. For example, inspection A 412, inspection B 422, inspection C 432, and inspection D 442 may be allocated to different Threads. According to an example, inspection A 412 may be allocated to Thread 1 410, inspection B 422 may be allocated to Thread 2 420, inspection C 432 may be allocated to Thread 3 430, and inspection D 442 may be allocated to Thread 4 440. Inspection A 412, inspection B 422, inspection C 432, and inspection D 442 allocated to different Threads may be performed in parallel during an overlapping time period.

Inspection A 412, inspection B 422, inspection C 432, and inspection D 442 may each be performed based on an associated HW component (or an inspection target HW component, an HW resource, or an HW component resource) (e.g., HW 1 414, HW 2 424, or HW 3 434). For example, inspection A 412 and inspection B 422 may be performed in association with HW 1 414, inspection C 432 may be performed in association with HW 2 424, and inspection D 442 may be performed in association with HW 3 434.

According to an example, the inspection data collected by the electronic device 110 or the server 130 may include data associated with a failure rate of each of simultaneously performed inspection processes. For example, the inspection data may include, as failure rate data based on previous execution results, first failure rate data 460 associated with inspection A 412, second failure rate data 470 associated with inspection B 422, third failure rate data 480 associated with inspection C 432, or fourth failure rate data 490 associated with inspection D 442.

According to an example, in case that inspection A 412 and one of inspection B 422, inspection C 432, and inspection D 442 are simultaneously performed, the first failure rate data 460 may include a failure rate of each of inspection B 422, inspection C 432, and inspection D 442. For example, in case that inspection B 422 is performed while inspection A 412 is being performed, the failure rate of inspection B 422 may be 85%, in case that inspection C 432 is performed while inspection A 412 is being performed, the failure rate of inspection C 432 may be 2% and, in case that inspection D 442 is performed while inspection A 412 is being performed, the failure rate of inspection D 442 may be 1%.

According to an example, in case that inspection B 422 and one of inspection A 412, inspection C 432, and inspection D 442 are simultaneously performed, the second failure rate data 470 may include a failure rate of each of inspection A 412, inspection C 432, and inspection D 442. For example, in case that inspection A 412 is performed while inspection B 422 is being performed, the failure rate of inspection A 412 may be 2%, in case that inspection C 432 is performed while inspection B 422 is being performed, the failure rate of inspection C 432 may be 2% and, in case that inspection D 442 is performed while inspection B 422 is being performed, the failure rate of inspection D 442 may be 1%.

According to an example, in case that inspection C 432 and one of inspection A 412, inspection B 422, and inspection D 442 are simultaneously performed, the third failure rate data 480 may include a failure rate of each of inspection A 412, inspection B 422, and inspection D 442. For example, in case that inspection A 412 is performed while inspection C 432 is being performed, the failure rate of inspection A 412 may be 1%, in case that inspection B 422 is performed while inspection C 432 is being performed, the failure rate of inspection B 422 may be 2% and, in case that inspection D 442 is performed while inspection C 432 is being performed, the failure rate of inspection D 442 may be 1%.

According to an example, in case that inspection D 442 and one of inspection A 412, inspection B 422, and inspection C 432 are simultaneously performed, the fourth failure rate data 490 may include a failure rate of each of inspection A 412, inspection B 422, and inspection C 432. For example, in case that inspection A 412 is performed while inspection D 442 is being performed, the failure rate of inspection A 412 may be 1%, in case that inspection B 422 is performed while inspection D 442 is being performed, the failure rate of inspection B 422 may be 2% and, in case that inspection C 432 is performed while inspection D 442 is being performed, the failure rate of inspection C 432 may be 1%.

According to an example, the electronic device 110 or the server 130 may identify a failure rate equal to or greater than a threshold from the first failure rate data 460, the second failure rate data 470, the third failure rate data 480, or the fourth failure rate data 490. For example, in case that the threshold is 40%, the electronic device 110 or the server 130 may identify the failure rate of 85% of inspection B 422 from the first failure rate data 460 as a failure rate equal to or greater than the threshold. The electronic device 110 or the server 130 may perform scheduling such that inspection B 422 is not simultaneously performed with inspection A 412, based on the failure rate of inspection B 422 being equal to or greater than the threshold. For example, the electronic device 110 or the server 130 may perform scheduling such that inspection A 412 and inspection B 422 are not performed during an identical time period or an overlapping time period.

According to an example, the electronic device 110 or the server 130 may identify, from the first failure rate data 460, the second failure rate data 470, the third failure rate data 480, or the fourth failure rate data 490, a failure rate that is higher than other failure rates, a failure rate whose difference from other failure rates is equal to or greater than a set difference, or a highest failure rate. For example, the electronic device 110 or the server 130 may identify the failure rate of 85% of inspection B 422 included in the first failure rate data 460 as a failure rate higher than other failure rates (e.g., 1% or 2%), a failure rate whose difference from other failure rates is equal to or greater than a set difference (e.g., 20%), or a highest failure rate.

The electronic device 110 or the server 130 may perform scheduling such that inspection B 422 is not simultaneously performed with inspection A 412, considering the identified failure rate, e.g., the failure rate of inspection B 422 included in the first failure rate data 460. For example, the electronic device 110 or the server 130 may perform scheduling such that inspection A 412 and inspection B 422 are allocated to different Threads and performed during different time periods or non-overlapping time periods. According to an example, the electronic device 110 or the server 130 may perform scheduling of inspection B 422 or adjust an execution order or an inspection order of inspection B 422 such that inspection B 422 is performed before a start time or after an end time of inspection A 412.

According to an example, unlike what is illustrated in FIG. 4A, data associated with a success rate of each of simultaneously performed inspection processes may also be included in the inspection data. For example, the inspection data may include, as success rate data based on previous execution results, first success rate data associated with inspection A 412, second success rate data associated with inspection B 422, third success rate data associated with inspection C 432, or fourth success rate data associated with inspection D 442.

According to an example, the electronic device 110 or the server 130 may identify a success rate less than a threshold from the first success rate data, the second success rate data, the third success rate data, or the fourth success rate data. For example, in case that the threshold is 80%, the electronic device 110 or the server 130 may identify the success rate of 15% of inspection B 422 from the first success rate data as a success rate less than the threshold. The electronic device 110 or the server 130 may perform scheduling such that inspection B 422 is not simultaneously performed with inspection A 412, based on the success rate of inspection B 422 being less than the threshold. For example, the electronic device 110 or the server 130 may perform scheduling such that inspection A 412 and inspection B 422 are not performed during an identical time period or an overlapping time period.

According to an example, the electronic device 110 or the server 130 may identify, from the first success rate data, the second success rate data, the third success rate data, or the fourth success rate data, a success rate that is lower than other success rates, a success rate whose difference from other success rates is equal to or greater than a set difference, or a lowest success rate. For example, the electronic device 110 or the server 130 may identify the success rate of 15% of inspection B 422 included in the first success rate data as a success rate lower than other success rates (e.g., 99% or 98%), a success rate whose difference from other success rates is equal to or greater than a set difference (e.g., 20%), or a lowest success rate.

The electronic device 110 or the server 130 may perform scheduling such that inspection B 422 is not simultaneously performed with inspection A 412, considering the identified success rate, e.g., the success rate of inspection B 422 included in the first success rate data. For example, the electronic device 110 or the server 130 may perform scheduling such that inspection A 412 and inspection B 422 are allocated to different Threads and performed during different time periods or non-overlapping time periods. According to an example, the electronic device 110 or the server 130 may perform scheduling of inspection B 422 or adjust an execution order or an inspection order of inspection B 422 such that inspection B 422 is performed before a start time or after an end time of inspection A 412.

FIG. 4B is a view illustrating data associated with a required time of each of simultaneously performed inspection processes according to an embodiment.

Referring to FIG. 4B, the inspection data collected by the electronic device 110 or the server 130 may include data associated with a required time of each of simultaneously performed inspection processes. For example, the inspection data may include, as required time data based on previous execution results, first required time data 462 associated with inspection A 412, second required time data 472 associated with inspection B 422, third required time data 482 associated with inspection C 432, or fourth required time data 492 associated with inspection D 442.

According to an example, the first required time data 462 associated with inspection A 412 may include required time information or required time range information (e.g., 100 to 500 ms) in case that inspection A 412 is performed (or in case that execution succeeds). The first required time data 462 may include required time information in case that inspection A 412 is simultaneously performed with at least one of inspection B 422, inspection C 432, and inspection D 442. For example, the first required time data 462 may include required time information (e.g., 100 ms) in case that inspection A 412 is simultaneously performed with inspection C 432 and inspection D 442, and required time information (e.g., 500 ms) in case that inspection A 412 is simultaneously performed with inspection B 422, inspection C 432, and inspection D 442.

According to an example, the second required time data 472 associated with inspection B 422 may include required time information or a required time range (e.g., 100 to 500 ms) in case that inspection B 422 is performed (or in case that execution succeeds). The second required time data 472 may include required time information in case that inspection B 422 is simultaneously performed with at least one of inspection A 412, inspection C 432, and inspection D 442. For example, the second required time data 472 may include required time information (e.g., 100 ms) in case that inspection B 422 is simultaneously performed with inspection C 432 and inspection D 442, and required time information (e.g., 500 ms) in case that inspection B 422 is simultaneously performed with inspection A 412, inspection C 432, and inspection D 442.

According to an example, the third required time data 482 associated with inspection C 432 may include required time information or a required time range (e.g., 100 to 100 ms) in case that inspection C 432 is performed (or in case that execution succeeds). The third required time data 482 may include required time information in case that inspection C 432 is simultaneously performed with at least one of inspection A 412, inspection B 422, and inspection D 442. For example, the third required time data 482 may include required time information (e.g., 100 ms) in case that inspection C 432 is simultaneously performed with inspection B 422 and inspection D 442, and required time information (e.g., 100 ms) in case that inspection C 432 is simultaneously performed with inspection A 412, inspection B 422, and inspection D 442.

According to an example, the fourth required time data 492 associated with inspection D 442 may include required time information or a required time range (e.g., 100 to 100 ms) in case that inspection D 442 is performed (or in case that execution succeeds). The fourth required time data 492 may include required time information in case that inspection D 442 is simultaneously performed with at least one of inspection A 412, inspection B 422, and inspection C 432. For example, the fourth required time data 492 may include required time information (e.g., 100 ms) in case that inspection D 442 is simultaneously performed with inspection B 422 and inspection C 432, and required time information (e.g., 100 ms) in case that inspection D 442 is simultaneously performed with inspection A 412, inspection B 422, and inspection C 432.

According to an example, the electronic device 110 or the server 130 may identify a required time equal to or greater than a threshold time from the first required time data 462, the second required time data 472, the third required time data 482, or the fourth required time data 492. For example, in case that the threshold time is 300 ms, the electronic device 110 or the server 130 may identify that the required time (e.g., 500 ms) in case that inspection A 412 is simultaneously performed with inspection B 422, inspection C 432, and inspection D 442 from the first required time data 462, and the required time (e.g., 500 ms) in case that inspection B 422 is simultaneously performed with inspection A 412, inspection C 432, and inspection D 442 from the second required time data 472, are equal to or greater than the threshold time.

The electronic device 110 or the server 130 may perform scheduling such that inspection A 412 is not simultaneously performed with inspection B 422, inspection C 432, and inspection D 442, and perform scheduling such that inspection B 422 is not simultaneously performed with inspection A 412, inspection C 432, and inspection D 442, based on the required time equal to or greater than the threshold time being identified. For example, the electronic device 110 or the server 130 may allocate inspection A 412, inspection B 422, inspection C 432, and inspection D 442 to different Threads, and allocate the time period during which inspection A 412 is performed and the time period during which inspection B 422, inspection C 432, and inspection D 442 are performed differently. For example, the electronic device 110 or the server 130 may allocate the time period during which inspection B 422 is performed and the time period during which inspection C 432 and inspection D 442 are performed differently. The allocation of different time periods may prevent overlapping of time periods, and thus may readdress the issues of the threshold time increasing due to simultaneous execution.

According to an example, the electronic device 110 or the server 130 may identify, from the first required time data 462, the second required time data 472, the third required time data 482, or the fourth required time data 492, a required time that is longer than other required times or a longest required time. For example, the electronic device 110 or the server 130 may identify the required time (e.g., 500 ms) in case that inspection A 412 is simultaneously performed with inspection B 422, inspection C 432, and inspection D 442 from the first required time data 462, and the required time (e.g., 500 ms) in case that inspection B 422 is simultaneously performed with inspection A 412, inspection C 432, and inspection D 442 from the second required time data 472, as a required time longer than other required times or a longest required time. The electronic device 110 or the server 130 may perform scheduling such that inspection A 412 is not simultaneously performed with inspection B 422, inspection C 432, and inspection D 442, and perform scheduling such that inspection B 422 is not simultaneously performed with inspection A 412, inspection C 432, and inspection D 442, based on the required time longer than other data or the longest required time being identified.

FIG. 4C is a view illustrating data associated with an available inspection start time after booting of each of simultaneously performed inspection processes according to an embodiment.

Referring to FIG. 4C, the inspection data collected by the electronic device 110 or the server 130 may include data associated with an available inspection start time after booting of each of simultaneously performed inspection processes. For example, the data associated with the available inspection start time after booting may include start/end time data that is data associated with an inspection start time and an inspection end time.

According to an example, first start/end time data 464 associated with inspection A 412 may include inspection start time information (e.g., 10 to 15 seconds after booting) and inspection end time information (e.g., 12 to 17 seconds after booting) in case that execution of inspection A 412 succeeds, and inspection start time information (e.g., 1 to 10 seconds after booting) and inspection end time information (e.g., 1 to 10 seconds after booting) in case that execution of inspection A 412 fails.

According to an example, second start/end time data 474 associated with inspection B 422 may include inspection start time information (e.g., 1 to 15 seconds after booting) and inspection end time information (e.g., 8 to 25 seconds after booting) in case that execution of inspection B 422 succeeds, and inspection start time information (e.g., 1 to 15 seconds after booting) and inspection end time information (e.g., 8 to 25 seconds after booting) in case that execution of inspection B 422 fails.

According to an example, third start/end time data 484 associated with inspection C 432 may include inspection start time information (e.g., 1 to 15 seconds after booting) and inspection end time information (e.g., 8 to 25 seconds after booting) in case that execution of inspection C 432 succeeds, and inspection start time information (e.g., 1 to 15 seconds after booting) and inspection end time information (e.g., 8 to 25 seconds after booting) in case that execution of inspection C 432 fails.

According to an example, fourth start/end time data 494 associated with inspection D 442 may include inspection start time information (e.g., 1 to 15 seconds after booting) and inspection end time information (e.g., 8 to 25 seconds after booting) in case that execution of inspection D 442 succeeds, and inspection start time information (e.g., 1 to 15 seconds after booting) and inspection end time information (e.g., 8 to 25 seconds after booting) in case that execution of inspection D 442 fails.

According to an example, the electronic device 110 or the server 130 may identify, based on the first start/end time data 464, the second start/end time data 474, the third start/end time data 484, or the fourth start/end time data 494, whether each of inspection A 412, inspection B 422, inspection C 432, and inspection D 442 requires a time for performing an inspection process after booting (e.g., a time for HW initialization), or whether there is a meaningful difference or a significant difference between the inspection start time and/or the inspection end time in case that each of inspection A 412, inspection B 422, inspection C 432, and inspection D 442 succeeds and the inspection start time and/or the inspection end time in case that each of inspection A 412, inspection B 422, inspection C 432, and inspection D 442 fails.

For example, the electronic device 110 or the server 130 may identify, based on the first start/end time data 464, that execution fails in case that inspection A 412 starts at 1 to 10 seconds after booting, and execution succeeds in case that inspection A 412 starts at 10 to 15 seconds after booting. Considering this, the electronic device 110 or the server 130 may determine the available inspection start time of inspection A 412 to be 10 to 15 seconds after booting.

The electronic device 110 or the server 130 may identify the available inspection start time of inspection B 422, inspection C 432, or inspection D 442 based on the second start/end time data 474, the third start/end time data 484, or the fourth start/end time data 494. For example, there may be no difference between the inspection start time and/or the inspection end time in case that each of inspection B 422, inspection C 432, or inspection D 442 succeeds and the inspection start time and/or the inspection end time in case that each of inspection B 422, inspection C 432, or inspection D 442 fails. Considering this, the electronic device 110 or the server 130 may identify the available inspection start time of each of inspection B 422, inspection C 432, or inspection D 442 as 1 to 15 seconds after booting. The electronic device 110 or the server 130 may schedule inspection B 422, inspection C 432, or inspection D 442 to be performed at a time earlier than inspection A 412, based on the available inspection start time of each of inspection B 422, inspection C 432, or inspection D 442 being earlier than the available inspection start time of inspection A 412.

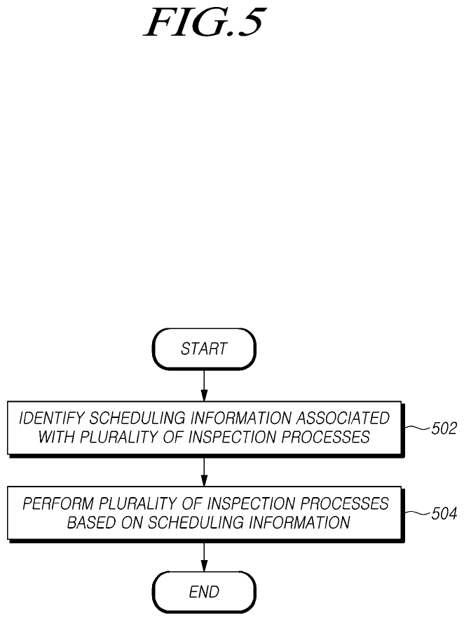

FIG. 5 is a flowchart illustrating an operation of an electronic device according to an embodiment.

Referring to FIG. 5, in operation 502, the electronic device 110 may identify scheduling information associated with a plurality of inspection processes.

In operation 504, the electronic device 110 may perform the plurality of inspection processes based on the identified scheduling information. According to an example, execution time periods of the plurality of inspection processes indicated by the scheduling information may overlap or may not overlap.

According to an example, the scheduling information may be determined based on inspection data associated with previous execution results of the plurality of inspection processes. For example, the inspection data may include at least one of a failure rate of each of the plurality of inspection processes based on execution time periods of the plurality of inspection processes overlapping, a required time of each of the plurality of inspection processes based on execution time periods of the plurality of inspection processes overlapping, or data associated with an available inspection start time after booting of each of the plurality of inspection processes.

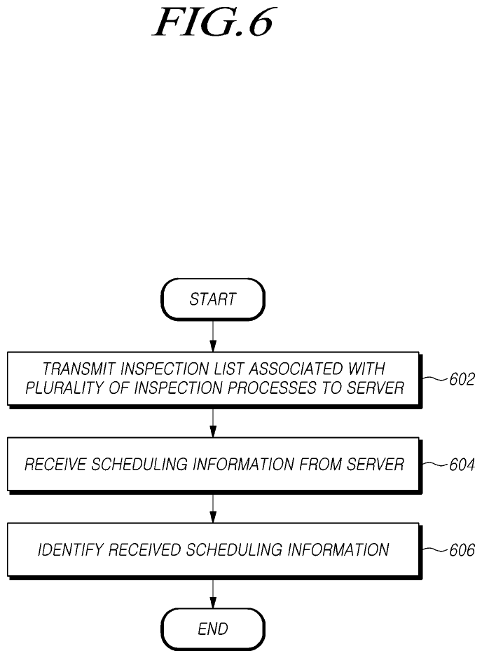

According to an example, the operation of the electronic device 110 identifying the scheduling information in operation 502 of FIG. 5 may be performed in various ways. For example, the electronic device 110 may identify the scheduling information based on operations illustrated in any one of FIGS. 6 to 8.

FIG. 6 is a flowchart illustrating an operation in which an electronic device identifies scheduling information according to an embodiment.

The operations of FIG. 6 may be performed based on the electronic device 110 being capable of communication with the server 130. For example, the operations of FIG. 6 may be performed based on the server 130 performing scheduling for a plurality of inspection processes on the system 100 of FIG. 1.

Referring to FIG. 6, in operation 602, the electronic device 110 may transmit an inspection list associated with the plurality of inspection processes to the server 130. According to an example, the inspection list may include identification information or model information of the electronic device 110 and/or information on the HW components included in the electronic device 110.

In operation 604, the electronic device 110 may receive scheduling information associated with the plurality of inspection processes from the server 130, in response to having transmitted the inspection list.

In operation 606, the electronic device 110 may identify the received scheduling information. According to an example, the electronic device 110 may determine a time period (or a start time and/or an end time) for performing each of the plurality of inspection processes or an execution order of each of the plurality of inspection processes, based on the scheduling information.

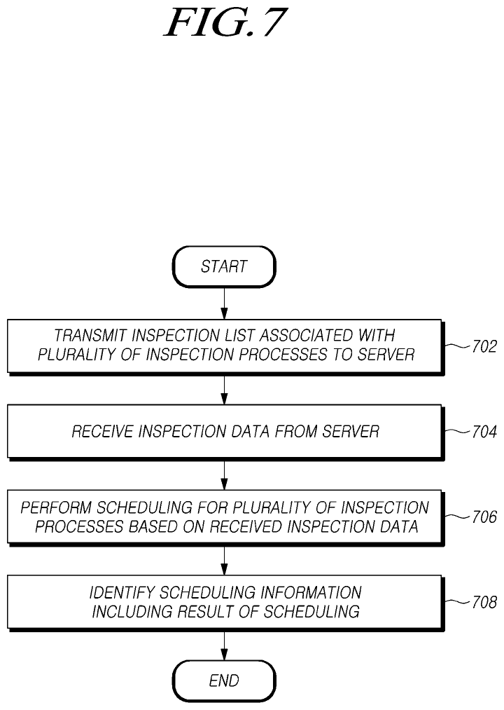

FIG. 7 is a flowchart illustrating another operation in which an electronic device identifies scheduling information according to an embodiment.

The operations of FIG. 7 may be performed based on the electronic device 110 being capable of communication with the server 130. For example, the operations of FIG. 7 may be performed based on the electronic device 110 performing scheduling for a plurality of inspection processes on the system 100 of FIG. 1.

Referring to FIG. 7, in operation 702, the electronic device 110 may transmit an inspection list associated with the plurality of inspection processes to the server 130.

In operation 704, the electronic device 110 may receive inspection data from the server 130, in response to having transmitted the inspection list.

In operation 706, the electronic device 110 may perform scheduling for the plurality of inspection processes based on the received inspection data. According to an example, the received inspection data may include data associated with previous execution results of the plurality of inspection processes (e.g., at least one of a failure rate, a required time, or data associated with an available inspection start time after booting). The data associated with the previous execution results may be collected by the server 130 and may be associated with a result of the plurality of inspection processes previously performed by one or more electronic devices including the electronic device 110.

In operation 708, the electronic device 110 may identify scheduling information including a result of the scheduling. According to an example, the electronic device 110 may determine a time period (or a start time and/or an end time) for performing each of the plurality of inspection processes or an execution order of each of the plurality of inspection processes, based on the scheduling information.

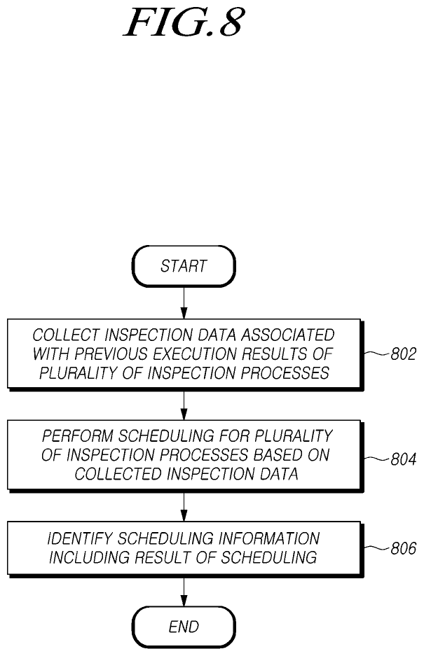

FIG. 8 is a flowchart illustrating yet another operation in which an electronic device identifies scheduling information according to an embodiment.

The operations of FIG. 8 may be performed based on the electronic device 110 performing scheduling for a plurality of inspection processes without performing communication with the server 130.

Referring to FIG. 8, in operation 802, the electronic device 110 may collect inspection data associated with previous execution results of the plurality of inspection processes.

In operation 804, the electronic device 110 may perform scheduling for the plurality of inspection processes based on the collected inspection data.

In operation 806, the electronic device 110 may identify scheduling information including a result of the scheduling. According to an example, the electronic device 110 may determine a time period (or a start time and/or an end time) for performing each of the plurality of inspection processes or an execution order of each of the plurality of inspection processes, based on the scheduling information.

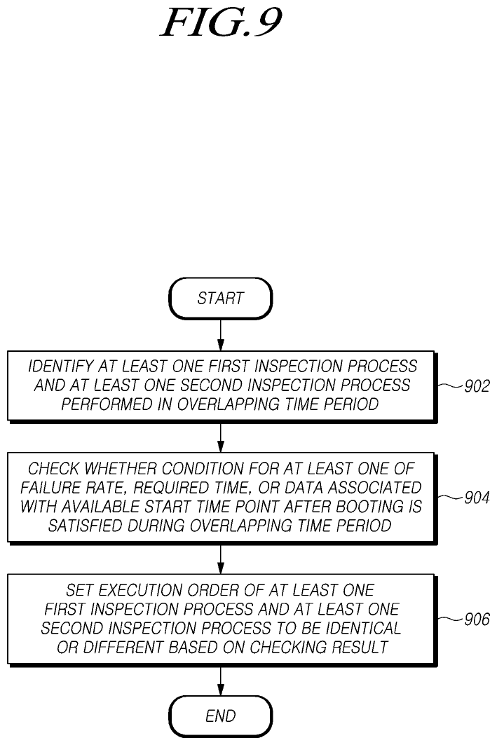

FIG. 9 is a flowchart illustrating an operation in which an electronic device or a server sets an execution order of an inspection process according to an embodiment.

Referring to FIG. 9, in operation 902, the electronic device 110 or the server 130 may identify at least one first inspection process and at least one second inspection process performed in an overlapping time period. According to an example, the electronic device 110 or the server 130 may identify the at least one first inspection process and the at least one second inspection process based on inspection data.

In operation 904, the electronic device 110 or the server 130 may identify whether a condition associated with the inspection data (e.g., a condition for at least one of a failure rate, a required time, or data associated with an available inspection start time after booting) is satisfied during the overlapping time period. For example, the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

In operation 906, the electronic device 110 or the server 130 may set the execution order of the at least one first inspection process and the at least one second inspection process to be identical or different, based on a result of the checking. According to an example, an identical execution order may represent an order in which execution time periods overlap, and a different execution order may represent an order in which execution time periods do not overlap.

According to an example, in case that the execution order of the at least one first inspection process and the at least one second inspection process is set to be different, the execution order of the at least one first inspection process may be set to an order before execution of the at least one second inspection process starts, or an order after execution of the at least one second inspection process ends.

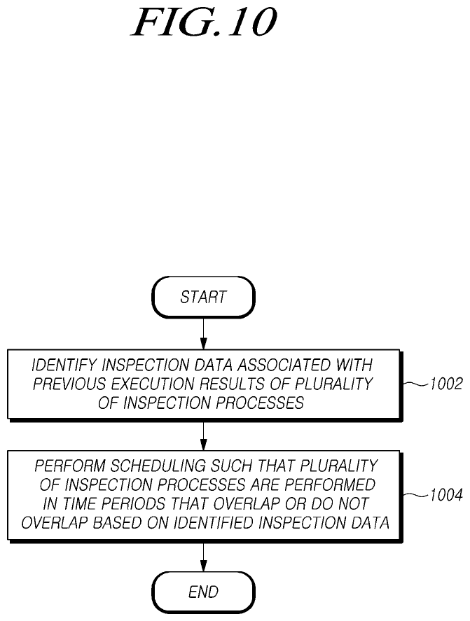

FIG. 10 is a flowchart illustrating operations of a server according to an embodiment;

In operation 1002, the server 130 may identify inspection data associated with previous execution results of a plurality of inspection processes. According to an example, the inspection data may include at least one of a failure rate of each of the plurality of inspection processes based on execution time periods of the plurality of inspection processes overlapping, a required time of each of the plurality of inspection processes based on execution time periods of the plurality of inspection processes overlapping, or data associated with an available inspection start time after booting of each of the plurality of inspection processes.

In operation 1004, the server 130 may perform scheduling based on the identified inspection data such that the plurality of inspection processes are performed in time periods that overlap or do not overlap.

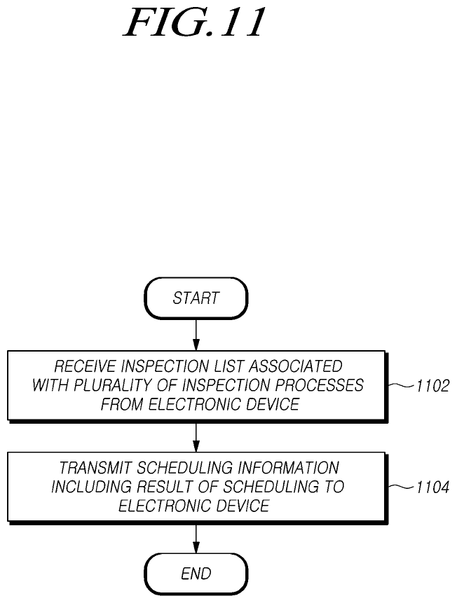

FIG. 11 is a flowchart illustrating an operation in which a server provides scheduling information to an electronic device according to an embodiment.

In operation 1102, the server 130 may receive an inspection list associated with a plurality of inspection processes from the electronic device 110.

In operation 1104, the server 130 may transmit scheduling information including a result of the scheduling to the electronic device 110, in response to having received the inspection list.

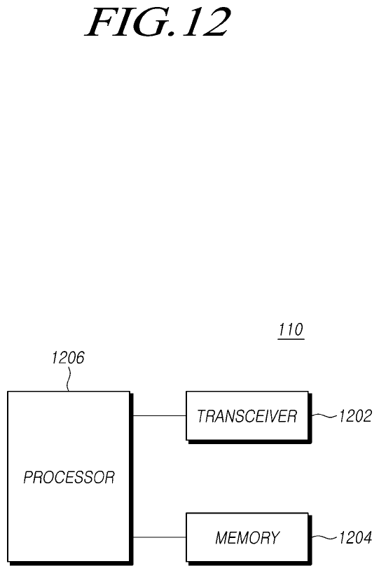

FIG. 12 is a block diagram illustrating a configuration of an electronic device according to an embodiment.

Referring to FIG. 12, the electronic device 110 may include a transceiver 1202, a memory 1204, and a processor 1206. According to an example, the electronic device 110 may include an additional component (e.g., a display) in addition to the illustrated components, or may omit at least one of the illustrated components.

According to an example, the transceiver 1202 may perform communication with the server 130. For example, the transceiver 1202 may perform communication with the server 130 based on wireless fidelity (Wi-Fi), Bluetooth, or other communication technology.

According to an example, the memory 1204 may store various information or data associated with an operation of the electronic device 110, and may store at least one program.

According to an embodiment, the processor 1206 may be electrically or operatively connected to the transceiver 1202 and the memory 1204, and may execute at least one instruction of the program stored in the memory 1204. The processor 1206 may be one or more, and may perform the previously described operations of the electronic device 110 (e.g., the operations of the electronic device 110 described with reference to FIGS. 1 to 9).

For example, the processor 1206 may identify scheduling information associated with a plurality of inspection processes, and perform the plurality of inspection processes based on the scheduling information. Execution time periods of the plurality of inspection processes indicated by the scheduling information may overlap or may not overlap.

According to an example, the scheduling information may be determined based on inspection data associated with previous execution results of the plurality of inspection processes. For example, the inspection data may include information on at least one of a failure rate of each of the plurality of inspection processes based on execution time periods of the plurality of inspection processes overlapping, a required time of each of the plurality of inspection processes based on execution time periods of the plurality of inspection processes overlapping, or an available inspection start time after booting of each of the plurality of inspection processes.

According to an example, the processor 1206 may control the transceiver 1202 to transmit an inspection list associated with the plurality of inspection processes to the server 130, and to receive scheduling information from the server 130 in response to having transmitted the inspection list.

According to an example, the processor 1206 may control the transceiver 1202 to transmit an inspection list associated with the plurality of inspection processes to the server 130, and to receive inspection data from the server 130 in response to having transmitted the inspection list. The processor 1206 may perform scheduling for the plurality of inspection processes based on the received inspection data, and identify scheduling information including a result of the scheduling.

According to an example, the processor 1206 may collect inspection data associated with previous execution results of the plurality of inspection processes, perform scheduling for the plurality of inspection processes based on the collected inspection data, and identify scheduling information including a result of the scheduling.

According to an example, the scheduling information may include information indicating an execution order of each of the plurality of inspection processes.

According to an example, an execution order of at least one first inspection process among the plurality of inspection processes may be determined to be different from an execution order of at least one second inspection process among the plurality of inspection processes, based on a condition associated with the inspection data. For example, the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

According to an example, the execution order of the at least one first inspection process may be an order before execution of the at least one second inspection process starts, or an order after execution of the at least one second inspection process ends.

According to an example, the plurality of inspection processes may be associated with a plurality of HW components included in the electronic device 110.

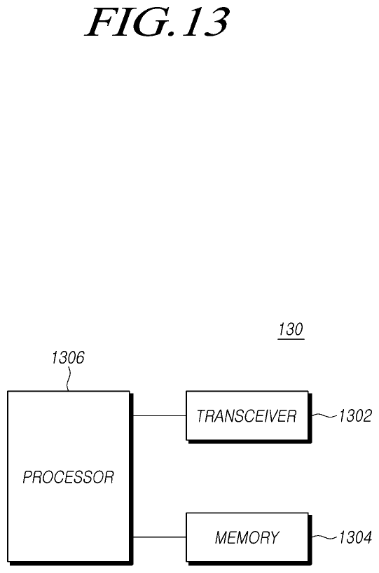

FIG. 13 is a block diagram illustrating a configuration of a server according to an embodiment.

Referring to FIG. 13, the server 130 may include a transceiver 1302, a memory 1304, and a processor 1306. According to an embodiment, the server 130 may include an additional component (e.g., a communication module for communication with another server or another electronic device) other than the illustrated components, or may omit at least one of the illustrated components.

According to an example, the transceiver 1302 may perform communication with the electronic device 110. For example, the transceiver 1302 may perform communication with the electronic device 110 based on wireless fidelity (Wi-Fi), Bluetooth, or other communication technology.

According to an example, the memory 1304 may store various information or data associated with an operation of the server 130, and may store at least one program.

According to an embodiment, the processor 1306 may be electrically or operatively connected to the transceiver 1302 and the memory 1304, and may execute at least one instruction of the program stored in the memory 1304. The processor 1306 may be one or more, and may perform the previously described operations of the server 130 (e.g., the operations of the server 130 described with reference to FIGS. 1 to 4C and FIGS. 9 to 11).

For example, the processor 1306 may identify inspection data associated with previous execution results of a plurality of inspection processes, and perform scheduling based on the identified inspection data such that the plurality of inspection processes are performed in time periods that overlap or do not overlap.

According to an example, the inspection data may include at least one of a failure rate of each of the plurality of inspection processes based on execution time periods of the plurality of inspection processes overlapping, a required time of each of the plurality of inspection processes based on execution time periods of the plurality of inspection processes overlapping, or data associated with an available inspection start time after booting of each of the plurality of inspection processes.

According to an example, the processor 1306 may control the transceiver 1302 to receive an inspection list associated with the plurality of inspection processes from the electronic device 110, and to transmit scheduling information including a result of the scheduling to the electronic device 110 in response to having received the inspection list.

According to an example, the processor 1306 may generate scheduling information including information indicating an execution order of each of the plurality of inspection processes, based on a result of the scheduling.

According to an example, an execution order of at least one first inspection process among the plurality of inspection processes may be determined to be different from an execution order of at least one second inspection process among the plurality of inspection processes, based on a condition associated with the inspection data. For example, the condition associated with the inspection data may include at least one of a first condition indicating that, based on execution time periods of the at least one first inspection process and the at least one second inspection process overlapping, a failure rate of the at least one first inspection process or the at least one second inspection process is equal to or greater than a threshold, a second condition indicating that, based on execution time periods of the at least one first inspection process and the at least one second inspection process overlapping, a required time of the at least one first inspection process or the at least one second inspection process is equal to or greater than a threshold time, or a third condition indicating that an available inspection start time after booting of the at least one first inspection process is different from an available inspection start time after booting of the at least one second inspection process.

The various embodiments and terms used herein are not intended to limit the technical features described herein to specific embodiments and should be understood to include various modifications, equivalents, or substitutes of the embodiment. In connection with the description of the drawings, like reference numerals may be used for similar or related components. In this document, each of the phrases such as “A or B,” “at least one of A and B,” “at least one of A or B,” “A, B or C,” “at least one of A, B and C,” and “at least one of A, B, or C” may include any one of the items enumerated together in a corresponding one of the phrases, or all possible combinations thereof. Terms such as “the first,” “the second,” or “first,” or “second” may be used simply to distinguish a corresponding component from another corresponding component, and do not limit the corresponding components in view of other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., wiredly), wirelessly, or via a third element.

The term “module” used in various embodiments of the document may include a unit implemented in hardware, software, or firmware and be used interchangeably with terms such as e.g., logic, logic block, part, component, or circuitry, for example. The module or unit may be a minimum unit or a part of the integrally configured component or the component that performs one or more functions. For example, according to an embodiment, the module or unit may be implemented in the form of an application-specific integrated circuit (ASIC).

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

1. An electronic device comprising:
memory to store at least one program; and
at least one processor electrically connectable to the memory and to execute at least one instruction of the at least one program stored in the memory, wherein the at least one processor is configured to:
identify scheduling information associated with a plurality of inspection processes; and
perform the plurality of inspection processes based on the scheduling information,
wherein execution time periods of the plurality of inspection processes indicated by the scheduling information overlap or do not overlap,
wherein the scheduling information is determined based on inspection data associated with previous execution results of the plurality of inspection processes, and
wherein the inspection data includes at least one of:
a failure rate corresponding to the plurality of inspection processes, respectively, based on time periods in which the plurality of inspection processes were performed overlapping;
a required time corresponding to the plurality of inspection processes, respectively, based on time periods in which the plurality of inspection processes were performed overlapping; or
data associated with an available inspection start time after booting of corresponding to the plurality of inspection processes, respectively.

2. The electronic device of claim 1, wherein the scheduling information is adjusted based on the inspection data subsequent to post-execution of the plurality of inspection processes.

3. The electronic device of claim 1, further comprising a transceiver to communicate with a server, and
wherein the at least one processor is configured to control the transceiver to transmit an inspection list associated with the plurality of inspection processes to the server, and based on the inspection list transmitted, receive the scheduling information from the server.

4. The electronic device of claim 1, further comprising a transceiver to communicate with a server, and
wherein the at least one processor is configured to:
control the transceiver to transmit an inspection list associated with the plurality of inspection processes to the server, and based on the inspection list transmitted, receive the inspection data from the server;
perform scheduling for the plurality of inspection processes based on the received inspection data; and
identify the scheduling information including a result of the scheduling.

5. The electronic device of claim 1, wherein the at least one processor is configured to:
collect inspection data associated with previous execution results of the plurality of inspection processes;
perform scheduling for the plurality of inspection processes based on the collected inspection data; and
identify the scheduling information including a result of the scheduling.

6. The electronic device of claim 1, wherein the scheduling information includes information indicating an execution order of each of the plurality of inspection processes,
wherein an execution order of at least one first inspection process among the plurality of inspection processes is determined to be different from an execution order of at least one second inspection process among the plurality of inspection processes, based on a condition associated with the inspection data, and
wherein the condition associated with the inspection data includes at least one of:
a first condition indicating that a failure rate of the at least one first inspection process or the at least one second inspection process is equal to or greater than a threshold, based on time periods in which the at least one first inspection process and the at least one second inspection process were performed overlapping;
a second condition indicating that a required time of the at least one first inspection process or the at least one second inspection process is equal to or greater than a threshold time, based on time periods in which the at least one first inspection process and the at least one second inspection process were performed overlapping; or
a third condition indicating that an available inspection start time after booting of the at least one first inspection process is different from an available inspection start time after booting of the at least one second inspection process.

7. The electronic device of claim 6, wherein the execution order of the at least one first inspection process is an order before execution of the at least one second inspection process starts, or an order after execution of the at least one second inspection process ends.

8. The electronic device of claim 1, wherein the plurality of inspection processes are associated with a plurality of hardware components included in the electronic device.

9. A server comprising:
memory to store at least one program; and
at least one processor electrically connectable to the memory and to execute at least one instruction of the at least one program stored in the memory, wherein the at least one processor is configured to:
identify inspection data associated with previous execution results of a plurality of inspection processes; and
perform scheduling such that the plurality of inspection processes are performed in time periods that overlap or do not overlap, based on the identified inspection data, and
wherein the inspection data includes at least one of:
a failure rate corresponding to the plurality of inspection processes, respectively, based on time periods in which the plurality of inspection processes were performed overlapping;
a required time corresponding to the plurality of inspection processes, respectively, based on time periods in which the plurality of inspection processes were performed overlapping; or
data associated with an available inspection start time after booting corresponding to the plurality of inspection processes, respectively.

10. The server of claim 9, wherein the scheduling is adjusted based on the inspection data subsequent to post-execution of the plurality of inspection processes.

11. The server of claim 9, further comprising a transceiver to communicate with an electronic device, and
wherein the at least one processor is configured to control the transceiver to receive an inspection list associated with the plurality of inspection processes from the electronic device, and based on receiving the inspection list, transmit scheduling information including a result of the scheduling to the electronic device.

12. The server of claim 9, wherein scheduling information including information indicating an execution order of each of the plurality of inspection processes is generated based on a result of the scheduling,
wherein an execution order of at least one first inspection process among the plurality of inspection processes is set to be different from an execution order of at least one second inspection process among the plurality of inspection processes, based on a condition associated with the inspection data, and
wherein the condition associated with the inspection data includes at least one of:
a first condition indicating that a failure rate of the at least one first inspection process or the at least one second inspection process is equal to or greater than a threshold, based on time periods in which the at least one first inspection process and the at least one second inspection process were performed overlapping;
a second condition indicating that a required time of the at least one first inspection process or the at least one second inspection process is equal to or greater than a threshold time, based on time periods in which the at least one first inspection process and the at least one second inspection process were performed overlapping; or
a third condition indicating that an available inspection start time after booting of the at least one first inspection process is different from an available inspection start time after booting of the at least one second inspection process.

13. A method of performing a plurality of inspection processes by an electronic device, the method comprising:
identifying scheduling information associated with the plurality of inspection processes; and
performing the plurality of inspection processes based on the scheduling information,
wherein execution time periods of the plurality of inspection processes indicated by the scheduling information overlap or do not overlap,
wherein the scheduling information is determined based on inspection data associated with previous execution results of the plurality of inspection processes, and
wherein the inspection data includes at least one of:
a failure rate corresponding to the plurality of inspection processes, respectively, based on time periods in which the plurality of inspection processes were performed overlapping;
a required time corresponding to the plurality of inspection processes, respectively, based on time periods in which the plurality of inspection processes were performed overlapping; or
data associated with an available inspection start time after booting corresponding to the plurality of inspection processes, respectively.

14. The method of claim 13, wherein the scheduling information is adjusted based on the inspection data subsequent to post-execution of the plurality of inspection processes.

15. The method of claim 13, wherein the identifying of the scheduling information comprises:
transmitting an inspection list associated with the plurality of inspection processes to a server;
based on transmitting the inspection list, receiving the scheduling information from the server; and
identifying the received scheduling information.

16. The method of claim 13, wherein the identifying of the scheduling information comprises:
transmitting an inspection list associated with the plurality of inspection processes to a server;
based on the inspection list transmitted, receiving the inspection data from the server;
performing scheduling for the plurality of inspection processes based on the received inspection data; and
identifying the scheduling information including a result of the scheduling.

17. The method of claim 13, wherein the identifying of the scheduling information comprises:
collecting inspection data associated with previous execution results of the plurality of inspection processes;
performing scheduling for the plurality of inspection processes based on the collected inspection data; and
identifying the scheduling information including a result of the scheduling.

18. A method of scheduling a plurality of inspection processes by a server, the method comprising:
identifying inspection data associated with previous execution results of the plurality of inspection processes; and
performing scheduling such that the plurality of inspection processes are performed in time periods that overlap or do not overlap, based on the identified inspection data, and
wherein the inspection data includes at least one of:
a failure rate corresponding to the plurality of inspection processes, respectively, based on time periods in which the plurality of inspection processes were performed overlapping;
a required time corresponding to the plurality of inspection processes, respectively, based on time periods in which the plurality of inspection processes were performed overlapping; or
data associated with an available inspection start time after booting corresponding to the plurality of inspection processes, respectively.

19. The method of claim 18, wherein the scheduling is adjusted based on the inspection data subsequent to post-execution of the plurality of inspection processes.

20. The method of claim 18, further comprising:
receiving an inspection list associated with the plurality of inspection processes from an electronic device; and
based on receiving the inspection list, transmitting scheduling information including a result of the scheduling to the electronic device.
